(19) United States
(12) Patent Application Publication
(10) Pub. No.: US 2006/0234768 A1
(43) Pub. Date: Oct. 19, 2006

(54) System and method for providing access to SMS messages for blind people and mobile communication device employing the same

(75) Inventors: Norman Goris, Dortmund (DE); Wolfgang Scheit, Sauerlach/Lochhofen (DE)

Correspondence Address: HITT GAINES, PC;AGERE SYSTEMS INC., PO BOX 832570, RICHARDSON, TX, 75083, US

(73) Assignee: Agere Systems Inc., Allentown, PA (US)

(21) Appl. No.: 11/109,515

(22) Filed: Apr. 19, 2005

(51) Int. Cl. H04M 1/00; H04Q 7/20; H04B 1/38

(52) U.S. Cl. 455/556.1; 455/566; 455/550.1; 455/466

(57) ABSTRACT

Mobile communication devices and methods relating to information output to a user of a mobile communication device, and especially to output for disabled users. To enable blind users to gain access to information, in particular text information, one method includes converting digital text information into electrical signals and employing the electrical signals to drive tactile output device in the mobile communication device.

### TECHNICAL FIELD OF THE PRESENT INVENTION

The present invention is directed, in general, to communication and, more specifically, to system and method for providing access to Short Message System (SMS) messages for blind people and a mobile communication device employing the same.

### BACKGROUND OF THE PRESENT INVENTION

Blind and partially sighted people have the same information and communication needs as everyone else. But many people with sight problems are not able to understand information unless it is made available to them in a suitable format. Print media employing tactile lettering such as Braille are already widespread, also voice calls using communication devices accordingly adapted to be operated by blind people are possible.

However, due to the typically larger operating elements such as buttons, mobile communication for blind people still is restricted. Especially for text messages like Short Message Service (SMS) messages, in particular exchanged via mobile communication devices, no solutions exist to enable access for blind people.

Accordingly, what is needed in the art is a new and easy approach for information output, especially text information output, in a communication device and in particular to provide an improved method and mobile communication device enabling a blind user to gain access to information, in particular text information.

### SUMMARY OF THE PRESENT INVENTION

To address the above-discussed deficiencies of the prior art, the present invention provides, in one aspect, a method for information output in a mobile communication device. In one embodiment, the method includes: (1) converting digital text information into electrical signals and (2) employing the electrical signals to drive tactile output device in the mobile communication device.

In another aspect, the present invention provides a mobile communication device. In one embodiment, the mobile communication device includes: (1) a converter configured to convert digital text information into electrical signals and (2) a tactile output device coupled to said converter and configured to provide said digital text information to a user.

The foregoing has outlined preferred and alternative features of the present invention so that those skilled in the art may better understand the detailed description of the present invention that follows. Additional features of the present invention will be described hereinafter that form the subject of the claims of the present invention. Those skilled in the art should appreciate that they may readily use the disclosed conception and specific embodiment as a basis for designing or modifying other structures for carrying out the same purposes of the present invention. Those skilled in the art should also realize that such equivalent constructions do not depart from the spirit and scope of the present invention.

### BRIEF DESCRIPTION OF THE DRAWINGS

For a more complete understanding of the present invention, reference is now made to the following descriptions taken in conjunction with the accompanying drawing, in which:

FIG. 1 illustrates a highly schematic diagram of a first embodiment of a mobile communication device provided with conductive surfaces as tactile output device constructed according to the principles of the present invention;

FIG. 2 illustrates a highly schematic diagram of a second embodiment of a mobile communication device provided with conductive surfaces and Braille type tactile elements as tactile output device constructed according to the principles of the present invention; and

FIG. 3 illustrates a block diagram components of one embodiment of a mobile communication device constructed according to the principles of the present invention.

### DETAILED DESCRIPTION

Before describing the FIGUREs directly, various aspects, embodiments and features of the present invention will be described. In one aspect, the present invention proposes a method for information output, in particular text information output, in a communication device, in particular a mobile communication device, a PDA or a MDA, including the steps of providing digital information, in particular text information, to be output, converting the digital information into electrical signals and providing the electrical signals by means of tactile output device implemented in the mobile communication device.

The method may be employed to provide a text message, in particular the text of a short message according to Short Message Service (SMS) standards, in a way that a blind user has access to the text message. This enables blind persons to participate in one of today's very popular communication means.

For the blind user to detect the output, the provision of electrical signals advantageously includes transmitting electrical signals to the user by means of a conductive surface. Since different users typically have a different sensitivity for detecting electrical signals, the method may include adjusting the signal strength of the electrical signals transmitted to the user according to user preferences.

The provision of electrical signals may also include the controlling of tactile elements forming a relief representing a Braille type character. The described tactile output device or any other suitable tactile output device may be used separately or in combination.

The converting of digital information into electrical signals may include retrieving information from a stored lookup table. The lookup table used may depend on the type of tactile output device employed. The lookup table that defines which electrical signal is associated with which character may be pre-defined by the user or the provider of the communication device and may also be updated.

An inventive communication device constructed according to the principles of the present invention may, depending upon the particular method used, include tactile output device adapted to provide digital information, in particular text information. The communication device may be a mobile communication device, such as a mobile communication device, a personal digital assistant (PDA) or a mobile digital assistant (MDA). The tactile output device may be adapted to provide the text of a short message according to SMS standards.

The tactile output device may be provided with at least one conductive surface for transmitting electrical signals to the user. The signal strength of the electrical signals transmitted to the user may be user-adjustable.

In another embodiment, the tactile output device is provided with at least one set of tactile elements adapted to form a relief representing a Braille type character.

For generating electrical signals, which may be provided by means of the described tactile output device, the inventive device may include a converter configured to convert digital information, in particular text information, into electrical signals. The specific design of the converter typically generally depends on the kind of tactile output device employed.

Since the digital information to be provided typically includes text information made up of single characters, the converter preferably employs a lookup table that includes a set of characters and their associated electrical signals. Accordingly, one embodiment of the device includes a memory unit configured to store at least one such lookup table.

The mobile communication device may be provided with a microprocessor having at least one associated memory unit. Accordingly, the present invention may be embodied in software configured to perform the method or communication device described above.

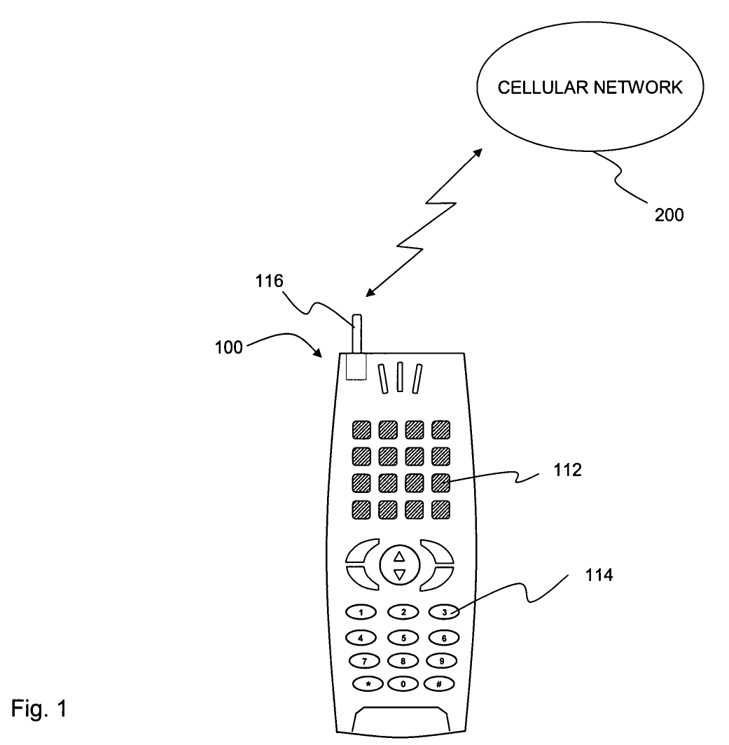

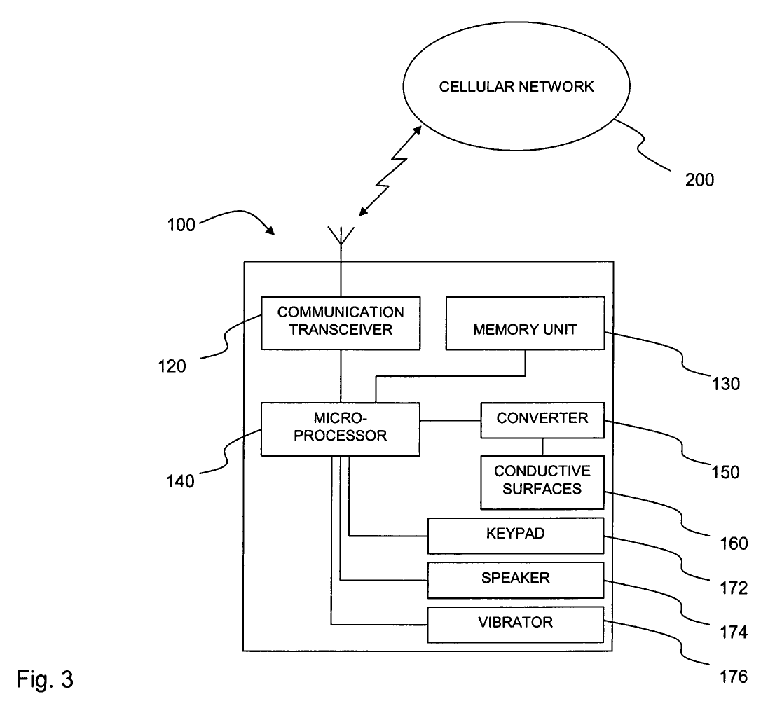

Referring initially to FIG. 1, illustrated is a highly schematic diagram of a first embodiment of a mobile communication device 100 provided with conductive surfaces as tactile output device constructed according to the principles of the present invention. The mobile communication device 100 has an antenna 16 for connecting to a cellular network 200 by an integrated communication transceiver (to be shown in FIG. 3).

As tactile output device the mobile communication device 100 is provided with an array of conductive surfaces 112 by which electrical signals may be transmitted to a user. These electrical signals are for example formed by the mobile communication device 100 by converting the text of an SMS message into electrical signals. The signals for single characters are predefined (e.g., Braille), thereby enabling the user to recognize what letter is coming, so that blind people advantageously are enabled to read SMS messages.

For the purpose of key recognition by a blind user, keys of a keypad 114 are preferably provided with fixed tactile marks like, for example, fixed Braille type information.

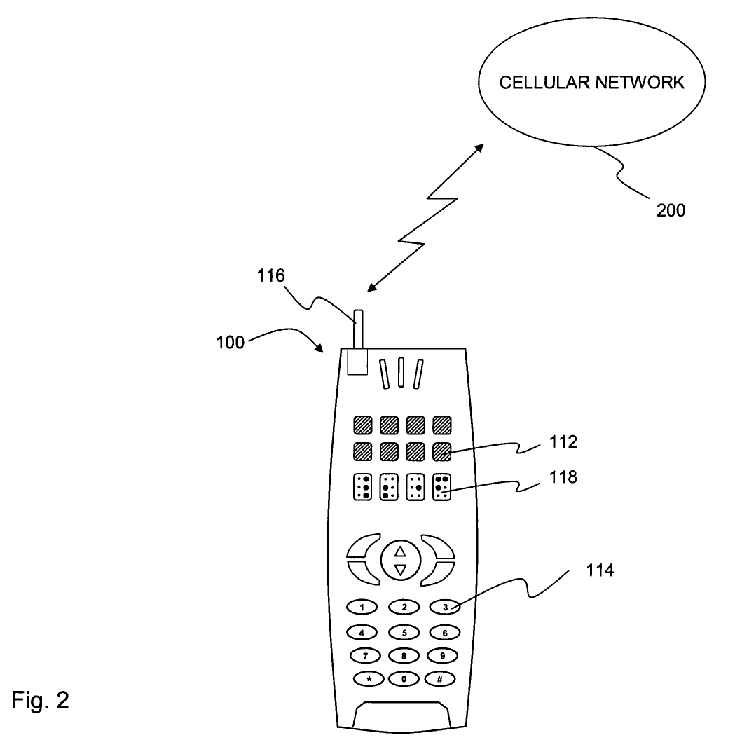

Turning now to FIG. 2, illustrated is a highly schematic diagram of a second embodiment of a mobile communication device 100 provided with conductive surfaces and Braille type tactile elements as tactile output device constructed according to the principles of the present invention. The mobile communication device 100 is similar to the one shown in FIG. 1. The mobile communication device 100 in this embodiment, though, is provided with a combination of two tactile output device, an array of conductive surfaces 112 for transmitting electrical signals to the user and a row of Braille elements 118, each including six tactile elements provided as retractable or extensible pins. Other suitable tactile output device may also be employed and is within the broad scope of the present invention. The combination of different tactile output device provides the blind user with an additional convenience allowing him to choose between the provided means depending for instance on personal preferences or desired output speed.

Turning now to FIG. 3, illustrated is a block diagram components of one embodiment of a mobile communication device 100 constructed according to the principles of the present invention. The mobile communication device 100 has a communication transceiver 120 adapted to communicate with a cellular network 200.

A memory unit 130 contains software that is executed by a microprocessor 140. The software is adapted to convert text information like that of an SMS message into electrical signals that are transmitted to the user by means of conductive surfaces 160. In the embodiment of FIG. 3, a separate converter 150 is provided for converting the text information into electrical signals, making use of a lookup table (not shown) in the memory unit 130. Further input and output components may include a keypad 172, a speaker 174 and a vibrator 176.

Exemplary, mobile communication devices have been described above as certain embodiments. The present invention however is in no way limited to mobile telephones, but also encompasses any other communication device, which is adapted for text information output.

Although the present invention has been described in detail, those skilled in the art should understand that they may make various changes, substitutions and alterations herein without departing from the spirit and scope of the present invention in its broadest form.

What is claimed is:

1. A method for information output in a mobile communication device, comprising:
converting digital text information into electrical signals; and
employing said electrical signals to drive tactile output device in said mobile communication device.

2. The method as recited in claim 1 wherein a mobile communication device is selected from the group consisting of:
a mobile telephone,
a personal digital assistant, and
a mobile digital assistant.

3. The method as recited in claim 1 wherein said digital text information is a short message conforming to Short Messaging Service standards.

4. The method as recited in claim 1 wherein said tactile output device comprises at least one conductive surface.

5. The method as recited in claim 3 wherein a signal strength of said electrical signals is adjustable according to user preferences.

6. The method as recited in claim 1 wherein said tactile output device comprises tactile elements configured to form a relief representing a Braille type character.

7. The method as recited in claim 1 wherein said converting of digital information into electrical signals comprises retrieving information from a lookup table.

8. The method as recited in claim 1 wherein said converting is carried out in software.

9. A mobile communication device, comprising:
a converter configured to convert digital text information into electrical signals; and
a tactile output device coupled to said converter and configured to provide said digital text information to a user.

10. The mobile communication device as recited in claim 9 wherein said digital text information is a short message conforming to Short Messaging Service standards.

11. The mobile communication device as recited in claim 9 wherein said tactile output device is provided with at least one conductive surface configured to transmit electrical signals to the user.

12. The mobile communication device as recited in claim 11 wherein a signal strength of said electrical signals is user-adjustable.

13. The mobile communication device as recited in claim 9 wherein said tactile output device comprises tactile elements configured to form a relief representing a Braille type character.

14. The mobile communication device as recited in claim 9 further comprising a memory unit configured to store a lookup table for said converting of said digital text information into said electrical signals.

15. The mobile communication device as recited in claim 8 wherein said converter is embodied in software.
